(19) United States
(12) Patent Application Publication
(10) Pub. No.: US 2007/0079705 A1
(43) Pub. Date: Apr. 12, 2007

(54) Heated Carbon Structure for Evaporative Emission Control Canister

(76) Inventor: Edward Donald Tolles, Charleston, SC (US)

Correspondence Address: MEADWESTVACO CORPORATION, Division and Technical Center - Law Dept., PO BOX 118005, CHARLESTON, SC, 29423-8005, US

(21) Appl. No.: 11/614,152

(22) Filed: Dec. 21, 2006

(51) Int. Cl. B01D 53/02; B60L 1/02; H05B 1/02; F02M 33/02

(52) U.S. Cl. 96/141; 123/519; 123/549; 96/144; 219/202; 219/504

(57) ABSTRACT

Activated carbon for automobile emission control canisters is disclosed to be heated by modular adsorbent structures within the canister in which activated carbon is bonded to very thin, electrically conductive heating elements, such that all of the carbon in the canister is in close proximity to a heated surface.

### BACKGROUND OF THE INVENTION

1. Field of the Invention

This invention relates to automotive emission control devices, e.g., canisters. In particular, the invention described and claimed herein is related to an adsorbent, preferably activate carbon structure, provided within the canister to adsorb emissions of volatile organic compounds emitted from the automobile's gasoline tank and from the engine at rest (after having been operating). More particularly, this invention relates to such a canister and/or adsorbent having been adapted for heating the adsorbent to increase its adsorption efficiency.

2. Description of the Prior Art

The working capacity and bleed performance of automotive evaporative emission control canisters can be significantly improved by providing heat to the carbon adsorbent during purge to offset the cooling that takes place as adsorbed hydrocarbons are desorbed. Thus, a challenge is how to input sufficient heat to the carbon (to sufficiently offset said cooling) without raising local temperatures to an unsafe level. Difficulty in providing good heat distribution in packed beds of activated carbon is a common problem because of the poor thermal conductivity of this highly porous material. The situation is exacerbated by the fact that when carbon material in closest contact with the heat source it loses a major portion of its hydrocarbon load, and its ability to sink heat suddenly diminishes. The low heat capacity of the clean carbon results in a rapid rise in carbon temperature.

In 1981, General Motors (in U.S. Pat. No. 4,280,466) described heating the purge air by means of a stove heated by the engine. Other patents, including U.S. Pat. No. 4,598,686 (1986), U.S. Pat. No. 4,778,495 (1988), and U.S. Pat. No. 4,864,103 (1989), consider heating purge air by electric heaters, including positive temperature coefficient heaters that self regulate temperatures to the desired range. Heating the influent purge air can be effective for transferring heat to the carbon, but this depends upon the amount of purge air that can be applied. Canister heating tests (at MeadWestvaco Corporation) using a 2 liter canister indicated that under cycle test purge conditions (150 bed volumes of purge for 20 minutes) direct electrical heating of the carbon at an input rate of 40 watts gave a 90% decrease in bleed emissions but yielded less than a 15% increase in working capacity. In order to attain the same heat input using heated air at low purge volumes, for example 50 bed volumes, the influent air would have to be heated to over 750° F. Assuming good heat transfer, the canister purge inlet and the carbon near the inlet would approach that temperature, which is clearly too high to be safe. Furthermore, in the example cited, a 15% improvement in working capacity might be considered too small to support the added complexity of carbon heating.

U.S. Pat. No. 4,919,103 (1990) teaches heating the carbon through the canister wall by contact with hot fuel from the fuel rail return line. Other patents, including U.S. Pat. No. 6,230,693 (2001), U.S. Pat. No. 6,279,547 (2001), U.S. Pat. No 6,701,902 (2004) and Published Application No. 10/151430 (published March 2004), describe various means of contacting carbon in canisters with electrically heated plates. By such arrangements, heat can be transferred directly to the carbon irrespective of the purge volume. The drawbacks of such arrangements relate, on one hand, to the space in the canister occupied by the heater assemblies, and on the other, to non-uniform distribution of the heat. Because of the very large porosity of activated carbon particles, and the high resistance to thermal flow at contact points between particles, thermal conductivity in packed beds of carbon is very poor. Therefore, attempts to heat activated carbon to useful regeneration temperatures by contact with a heated plate leads to large thermal gradients across a few particle diameters closest to the plate. This means that for uniform heat distribution the space between plates must be limited to a relatively few particle diameters. Accordingly, in the heating apparatuses of the prior art, a large part of the volume of the adsorption canister would have to be occupied by the heating plates in order to achieve a high degree of heating uniformity.

### SUMMARY OF THE INVENTION

Activated carbon for automobile emission control canisters is heated by modular adsorbent structures within the canister in which activated carbon is bonded to very thin, electrically conductive heating elements, such that all of the carbon in the canister is in close proximity to a heated surface. As deployed in this invention, the heating element is so thin as to occupy a negligible volume in the module. Heating activated carbon adsorbents during purge can provide a large improvement in bleed emission performance, and, if sufficient carbon can be heated, a large increase in working capacity is produced. The heating system of this invention provides a way to provide controlled heat distribution to a relatively large amount of activated carbon despite the very poor heat conductivity of this adsorbent.

### DESCRIPTION OF THE INVENTION

One objective of this invention is to provide a capability to introduce sufficient heat into an evaporative emission control canister to achieve a much greater improvement in working capacity than possible using methods of the prior art. Another objective is to provide very uniform heat distribution such that the input heat will not raise the local temperatures to an unsafe level. Still another objective is to configure the heating apparatus in such a way as to occupy only a very small part of the adsorption canister volume.

In the present invention, heat is electrically introduced directly to the carbon in the primary adsorption canister or a substantial partition (e.g., one third) thereof. In order to obtain a large increase in working capacity, the temperature of a significant fraction of the carbon adsorbent must be raised into the target range during purge. In accordance with the objectives of this invention, the heater assembly must therefore present a large surface area to the carbon, and at the same time the heater must have a very small volume. This can be accomplished, for example, by using an etched foil heater. One such heater (Omega KH212/5P), used in the previously mentioned canister test, had a total surface area of 310 cm² and a volume of only 6 cc, including an aluminum foil backing used to stiffen the assembly. This heater was formed into a spiral to make a tube shape with a diameter of 3.8 cm and a length of about 16 cm. This was inserted into a canister partition having a diameter of 6.4 cm and a volume of 560 cc as part of a total canister volume of 2000 cc. The part of the carbon bed lying outside of the heater tube represents the major fraction of carbon in the canister, and all particles in this annular region are within about five particle diameters from the heater surface. In the smaller volume inside the heater tube, all particles are within about six particle diameters from the heater surface. Experiments demonstrated that under purge conditions using 150 bed volumes of air (based on the total canister volume) in 20 minutes, the maximum rate of power input without exceeding a target heater surface temperature of 250° F., deemed to be safe, was 40 watts. Under these conditions, the volumetric working capacity was about 15% higher than for the unheated canister. This improvement is based on the assuming the same internal canister volume in both cases.

While these results demonstrate one efficient and effective means of transferring heat into a carbon canister, it is an object of this invention to achieve a substantially greater improvement in working capacity, for example at least twice as high. This could be accomplished by providing additional heater area in the canister using the same kind of etched foil heaters, with the drawback of substantial additional expense. Another approach would be to employ a heater element simply made from a strip of metal foil using a metal having a relatively high resistivity, for example, nichrome or stainless steel. In one embodiment, the foil strip would be coated on one side with an adhesive, and activated carbon granules would be applied to the adhesive in such a way as to give a random or oriented, close packed, two-dimensional array of particles attached to the foil. Preferably, the particles, such as pellets or spheres, would have a uniform diameter dimension, and the carbon layer would be of constant thickness, one particle deep. A length of this foil/carbon strip would then be rolled up to form a modular cylinder appropriate to particular canister dimensions. These modules would have approximately the same volume and flow restriction as a simple packed bed of particles containing the same amount of carbon. Heating efficiency would be excellent because each particle would be less than one particle diameter from a heated surface. As an example using nominal 2 mm diameter carbon pellets, three foil/carbon modules, 6.4 cm in diameter and 5.3 cm in height, would fill the canister partition of the previous example. Using 2 mil (0.00508 cm) stainless foil, and wired in series, this heater assembly could dissipate over 100 watts at 12 volts. An appropriate time-proportioning, or other type of controller, would modulate actual heat input based on temperature. In the present example, the objective of good heat distribution would be met by exposure of the carbon to a heater area of over 4900 cm². At the same time, the objective of minimal heater volume is attained because the heater of the example occupies only about 2% of the volume of the canister partition. In addition to metal foil, other conductive substrates could be used to support the adsorbent carbon. For example, stainless steel wire cloth in mesh sizes in the range of about 100 to 400 would exhibit volume and electrical resistivity properties similar to foils.

In another embodiment of this concept, the adsorbent pellets could be replaced with sheet forms of carbon which can be readily attached to the thin conductive backing. One way of producing such a sheet is by dispersing activated carbon in a fiber matrix as in the production of paper. Such sheets of carbon-loaded paper can include embossed ridges, such that when attached to the backing, and rolled-up, a cylindrical or other shaped body is formed with channels in the axial direction that allow airflow through the body. Alternatively, the carbon loaded paper can be corrugated with one liner sheet being made from conductive foil or wire cloth. In this case airflow is conducted by the fluted corrugations. In addition to using papermaking methods or other methods to produce carbon in suitable sheet form, such sheets can also be made by extrusion of carbon mixed with a suitable binder. For example, mixing carbon with small amounts of Teflon can produce an extrudable plastic mass. Formed into sheets, these could be adhesively attached to an electrically conductive backing, or extruded with, and pressed into, conductive wire cloth. This method offers an advantage over other sheet forming methods of including up to about 95% by weight of carbon in the formed sheet, thus increasing the potential adsorption capacity of an adsorption module.

I claim:

1. A modular adsorbent structure wherein adsorbent particles or sheets are attached to a thin backing material creating an adsorbent particle layer, which can be formed into various shapes to fit a housing for the purpose of fluid filtration.

2. The structure of claim 1 wherein the thickness of the adsorbent layer is at least five times the thickness of the backing material and the volume of the adsorbent is at least 15 times the volume of the backing material.

3. The structure of claim 1 wherein the backing material is conductive with an electrical resistivity between about 0.00005 and about 0.00015 ohm-cm.

4. The structure of claim 2 which is connected to an electrical power source for the purpose of electrical heating.

5. The structure of claim 1 wherein the adsorbent is activated carbon.

6. The structure of claim 1 wherein the housing is an automotive emission canister.
